(19) United States
(12) Patent Application Publication
(10) Pub. No.: US 2025/0284551 A1
(43) Pub. Date: Sep. 11, 2025

(54) METHOD AND DEVICE FOR IMPROVING MEMORY OPERATIONS

(71) Applicant: Samsung Electronics Co., Ltd., Suwon-si (KR)

(72) Inventors: Raghu Vamsi Krishna TALANKI, Bengaluru (IN); Sathisha S, Bengaluru (IN); Shaik Afreen ., Bengaluru (IN); Jin In SO, Suwon-si (KR); Jong Geon LEE, Suwon-si (KR); Rajeev VERMA, Bengaluru (IN); Vishnu Charan THUMMALA, Bengaluru (IN)

(73) Assignee: Samsung Electronics Co., Ltd., Suwon-si (KR)

(21) Appl. No.: 18/751,516

(22) Filed: Jun. 24, 2024

(30) Foreign Application Priority Data
Mar. 7, 2024 (IN) 202441016426

(51) Int. Cl. G06F 9/50

(52) U.S. Cl. CPC G06F 9/505; G06F 9/5016; G06F 9/5038

(57) ABSTRACT

A method performed by a host device to perform memory operations improving memory operations comprises receiving a request to perform at least one memory operation on a storage device. The method further includes determining a current processing load of a processing unit of the host device upon receiving the request to perform the at least one memory operation. The method further includes transmitting a configuration request to the storage device to configure a spare space within a storage controller of the storage device in response to determining that the current processing load exceeds a load threshold value. The configuring of the spare space includes allocating a plurality of registers within the spare space to perform the at least one memory operation on the storage device.

### CROSS-REFERENCE TO RELATED APPLICATIONS

This application is based on and claims priority under 35 USC § 119 to Indian patent application Ser. No. 20/244,1016426, filed on Mar. 7, 2024, in the Indian Patent Office, the disclosure of which is incorporated by reference herein in its entirety.

### BACKGROUND

Various example embodiments generally relate to improving or optimizing memory operations. Particularly, example embodiments relate to techniques for improving or optimizing memory operations by utilizing spare space within a storage device when performing the memory operations.

### BACKGROUND

In a storage system, a host device and a storage device typically communicate with each other to facilitate various memory operations. A memory operation is usually invoked via a system call and/or in response to a user request. A processing unit such as a central processing unit (CPU) of the host device is responsible for controlling the various memory operations (e.g., copy operations and/or move operations, but not limited thereto). In a typical memory copy operation, data from one memory location of the storage device is read and written to another memory location of the storage device.

In some scenarios where a large chunk of data needs to or is expected to be moved or copied, a processing load on the CPU increases. Memory operations involving bulk data copy/move would typically take more time than a move or copy operation involving less data. In such cases, essential CPU resources are wasted in simple memory read and/or write operations which could have been efficiently utilized in performing other complex operations.

### SUMMARY

One or more shortcomings discussed above may be overcome or improved upon, and additional advantages may be provided by various example embodiments.

As described herein, the need for offloading the CPU is addressed or at least partially addressed, particularly when the CPU is overloaded. Thus, example embodiments aim to more effectively conserve the CPU resources by utilizing a spare space present within a storage controller of a storage device when performing basic memory operations such as one or more of memory initialization, memory move, and memory copy operations.

According to some example embodiments a host device for improving or optimizing memory operations includes host memory and a processing unit communicatively coupled with the host memory. Further, the processing unit is configured to receive a request to perform at least one memory operation on a storage device. The processing unit is further configured to determine a current processing load of the processing unit of the host device upon receiving the request to perform the at least one memory operation. The processing unit is further configured to transmit a configuration request to the storage device to configure a spare space within a storage controller of the storage device, in response to determining that the current processing load exceeds a load threshold value. The configuring the spare space comprises allocating a plurality of registers within the spare space to perform the at least one memory operation on the storage device.

Alternatively or additionally according to some example embodiments, a method performed by a host device for improving or optimizing memory operations includes receiving a request to perform at least one memory operation on a storage device. The method comprises determining a current processing load of a processing unit of the host device on receiving the request to perform the at least one memory operation. The method further comprises transmitting a configuration request to the storage device to configure a spare space within a storage controller of the storage device in response to determining that the current processing load exceeds a load threshold value. The configuring of the spare space includes allocating a plurality of registers within the spare space to perform the at least one memory operation on the storage device.

Alternatively or additionally according to various example embodiments, a storage device for improving or optimizing memory operations includes a memory and a storage controller comprising a spare space and communicatively coupled with the memory. The storage controller is configured to receive a configuration request from a host device to perform at least one memory operation; and in response to receiving the configuration request, configure the spare space within the storage controller of the storage device. Here, the configuring the spare space comprises allocating a plurality of registers within the spare space to perform the at least one memory operation on the storage device.

Alternatively or additionally according to various example embodiments, a non-transitory computer readable medium for improving or optimizing memory operations includes one or more instructions which, when executed by a processing unit of a host device cause the host to receive a request to perform at least one memory operation on a storage device. The instructions further cause the processing unit to determine a current processing load of the processing unit of the host device upon receiving the request to perform the at least one memory operation. The instructions further cause the processing unit to transmit a configuration request to the storage device to configure a spare space within a storage controller of the storage device, in response to determining that the current processing load exceeds a load threshold value. The configuring of the spare space includes allocating a plurality of registers within the spare space to perform the at least one memory operation on the storage device.

Alternatively or additionally according to various example embodiments, a non-transitory computer readable medium for improving or optimizing memory operations includes one or more instructions which, when executed by a storage controller of a storage device cause the storage device to receive a configuration request from a host device to perform at least one memory operation and configure the spare space within the storage controller of the storage device, in response to receiving the configuration request. The configuring of the spare space includes allocating a plurality of registers within the spare space to perform the at least one memory operation on the storage device.

### BRIEF DESCRIPTION OF THE DRAWINGS

Further aspects and/or advantages of various embodiments will be readily understood from the following detailed description with reference to the accompanying drawings. Reference numerals have been used to refer to identical or functionally similar elements. The figures together with a detailed description below are incorporated in and form part of the specification and serve to further illustrate the embodiments and explain various principles and/or advantages, wherein:

FIG. 1 illustrates a high-level block diagram of an example storage system 100 comprising a host device 110 configured to communicate with a storage device 120.

FIG. 2 illustrates a detailed block diagram of an example storage system 200 comprising a host device 210 and a storage device 230.

FIG. 3 illustrates a high-level block diagram of a spare engine 300 associated with a storage device 230, in accordance with various example embodiments.

FIG. 4 illustrates a detailed block diagram of another example storage system 400, in accordance with various example embodiments.

FIG. 5 illustrates a flow chart of a method 500 performed by a host device for improving or optimizing memory operations, in accordance with various example embodiments.

FIG. 6 illustrates a flow chart of another method 600 performed by a storage device for improving or optimizing memory operations, in accordance with various example embodiments.

It should be appreciated by those of ordinary skill in the art that any block diagrams herein represent conceptual views of the illustrative systems embodying the principles of various example embodiments. Similarly, it will be appreciated that any flowcharts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

According to at least some embodiments, the memory operation may take the processing load on the CPU into consideration when performing memory operations, and may improve or optimize the memory operations.

While various modifications and/or alternative forms may be implemented, various embodiments thereof have been shown by way of example in the drawings and will be described in detail below. It should be understood, however that it is not intended to limit the disclosure to the particular forms disclosed, but on the contrary, example embodiments may cover all modifications, equivalents, and alternatives falling within the scope of various embodiments.

The terms like “SSD” and “SSD device” and “storage device” have been used interchangeably throughout the disclosure. Further, the terms like “host” and “host device” and “host computer” have been used interchangeably throughout the disclosure. The terms like “host controller” and “processor” and “processing unit” and “central processing unit” have been used interchangeably throughout the disclosure.

A typical storage system may comprise a memory device communicatively coupled with a host device and the storage device may comprise a Dynamic Random Access Memory (DRAM). Generally, DRAM is or includes a volatile memory that loses its stored data when power supplied to the memory is cut off. Typically, data is stored within the DRAM in form of data bits, where each data bit is represented as a memory cell in the DRAM. The memory cells may be organized into arrays of rows and columns; example embodiments are not limited thereto. DRAMs may also organized into a series of banks, and in the case of Synchronous RAM (SDRAMs) into ranks. Each bank is organized into the columns and the rows. The storage device apart from the DRAM, also includes a storage controller and optionally or additionally include a non-volatile memory such as a flash memory. Each of the storage controller, the DRAM, and the non-volatile memory may be a separate semiconductor die, chip, package, or module. Alternatively or additionally, at least one of the storage controller, the DRAM, and the non-volatile memory may be embodied in one or two semiconductor dies, chips, packages, or modules. The storage controller is generally responsible for controlling access to the DRAM. In particular the storage controller performs various rank-level and/or bank-level operations to select the memory bank or rank for writing data to and/or reading data from the DRAM. For performing these rank-level operations, storage controllers usually include a number of spare rank/bank registers dedicated for different ranks/banks of the DRAM/SDRAM. These spare rank/bank registers may collectively be referred as a spare engine. Further, within the spare engine, apart from the spare rank/bank registers, some additional spare space may also be available based on the configuration of the DRAM. Example embodiments aim to utilize this additional spare space to improve or optimize various memory operations. The various memory operations may comprise a memory copy operation. In a typical memory copy operation, data is read from one location (e.g., a source address) of a memory of the storage device and is written to another location (e.g., a destination address) within the memory.

A processing unit or central processing unit (CPU) of the host device is responsible for controlling the various memory operations (e.g., one or more of a copy operation, a move operation, an initialization operation, but not limited thereto). A scheduler of the CPU maintains a CPU run queue comprising all the processes the CPU is currently executing and/or is scheduled to execute. The more the number of processes on the CPU run queue, the more is processing load of the CPU. Consider a case when the CPU is scheduled to run a memory operation and the processing load of CPU is determined to be quite high. In such cases, other CPU processes may be stalled, e.g., may be stalled indefinitely, particularly in a case where a bulk memory move and/or copy operation is to be performed. In such cases, essential CPU resources may be wasted in simple memory read and write operations, as such resources could have been efficiently utilized in performing other complex processes.

To solve some or improve upon all or at least some of the above-identified problems, various example embodiments include techniques for effectively or more effectively conserving the CPU resources by utilizing spare space present within the storage controller of the storage device, while performing basic memory operations such as one or more of a memory initialization, a memory move, and a memory copy operation, particularly when the processing load of the CPU is high.

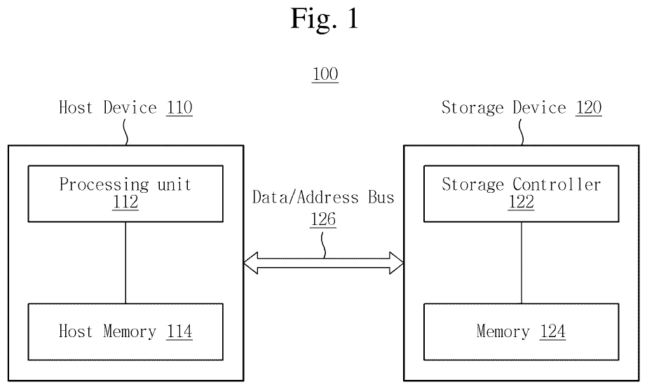

FIG. 1 illustrates a block diagram of an example storage system 100 showing a host device 110 communicatively coupled with a storage device 120. The host device 110 may comprise at least one processing unit 112 and a host memory 114. The host memory 114 may also be referred as main memory that stores or temporarily stores data and information to be transmitted to and/or received from the storage device 120. Further, the storage device 120 may comprise at least one storage controller 122 and a memory 124. The storage controller 122 controls access to various locations of the memory 124 of the storage device 120. In some non-limiting example embodiments, data between the host device 110 and the storage device 120 is transferred through one or more data buses and/or address buses 126. The data buses and/or address buses 126 may be or may include a wired bus and/or a wireless bus; example embodiments are not limited thereto.

In some non-limiting example embodiments, the host device 110 of FIG. 1 may be or may include or be included in any one or more of a mobile or non-mobile device such as, but not limited to, one or more of a portable communication terminal (e.g., a mobile phone), a smartphone, a tablet personal computer (PC), a wearable device, a healthcare device, an Internet of things (IOT) device, a Personal Computer (PC), a laptop computer, a server, a media player, or an automotive device (e.g., a navigation device). Further, the host device 110 may comprise one or more image capturing device, one or more input device, one or more output device, one or more sensors, at least one display device, at least one power source, and at least one connecting interface, but example embodiments are not limited thereto. The host memory 114 may be or include one or more of a volatile memory, such as static random-access memory (SRAM) and/or dynamic RAM (DRAM). In some example embodiments, the host memory may also include various cache memories utilized by host CPU in various processes.

In one or more non-limiting example embodiment, the processing unit 112 and the host memory 114 may be implemented as separate semiconductor chips. Alternatively, in some example embodiments, the processing unit 112 and the host memory 114 may be integrated in the same semiconductor chip. As an example, the processing unit 112 may be any one of a plurality of modules included in an application processor (AP). The AP may be implemented as a System on Chip (SoC). Further, the host memory 114 may be an embedded memory included in the AP or an NVM or memory module located outside the AP.

The host device 120 may be driven by executing an operating system. The operating system may include a device driver for controlling the storage device 120 at an operating system level. The device driver may be a software module, e.g., a Kernel module, for controlling the storage device 120. The host device 110 may request a write operation and/or a read operation on the storage device 120 through the device driver. The host device 110 may perform a read operation on a specific address in the storage device 120 by transmitting a memory request to the host device 110. In some example embodiments, the host device 110 may perform improved or optimized memory operations such as a memory copy, a memory move, and a memory initialize operation. The host device 110 may execute one or more of a video application, a game application, a Web browser application, and the like to provide various services.

In some example embodiments, the storage device 120 may include a memory such as a volatile memory 124 such as a SDRAM and/or DRAM configured to store data in response to requests from the host device 110. The storage device 120 may transmit data stored at a specific address to the host device 110 after receiving a read request from the host device 110.

In some example embodiments, the storage device 120 may be or may include or be included in s Solid-State Drive (SSD) device that also includes a non-volatile or flash-based memory. As an example, the storage device 120 may include at least one of an SSD, an embedded volatile memory, or any removable external memory.

In some non-limiting example embodiments, the storage controller 122 may either be part of the storage device 120 or may be physically separated from or implemented in an external device other than the storage device 120. Each configuration described herein may be made up of separate chips, modules, or devices, or may be included inside a single chip/module/device.

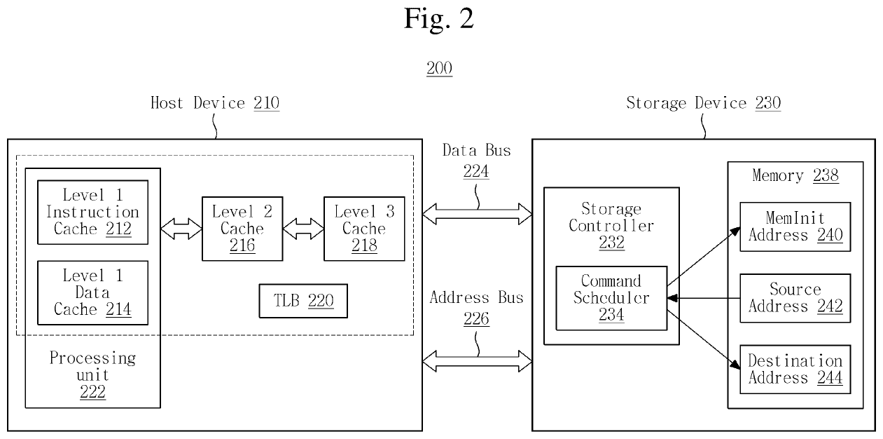

In a memory initialization operation, one or more memory locations of the DRAM are initialized to values such as pre-defined values stored in one or more registers of the DRAM. For example, the one or more main memory locations may be initialized to value 0 and/or to user-specified values. Whenever such a memory initialization request is received by the CPU 112, the CPU 112 becomes occupied during the entire duration, e.g., from the allocation of the memory space until the values are written into the allocated memory space of the DRAM 124. CPU resources are engaged during this time, irrespective of whether the processing load of the CPU is already high. Similar situation occurs in a memory move or copy operation, where data from one location (e.g., a source address) of the DRAM 124 of the storage device 120 is read and written to another location (e.g., a destination address) within the DRAM 124. In such situation, without considering the processing load of the CPU, the CPU resources are assigned to fulfil the memory requests for performing the memory read and/or write operations, as further explained in connection with FIG. 2.

FIG. 2 illustrates a detailed block diagram of a conventional storage system 200 comprising a host device 210 and a storage device 230. The host device 210 may comprise a CPU or a processing unit 222, cache memory, and a Translation Lookaside buffer (TLB) 220. The cache memory may comprise multiple levels to store frequently accessed data and instructions. The cache memory may be divided into multiple levels e.g., Level 1 cache (which includes data cache 214 or instruction cache 212), Level 2 cache 216, and Level 3 cache 218. The TLB 220 is a memory cache that stores most frequent or recent most address translations of a virtual memory to physical memory. The TLB 220 aims to reduce time taken to access a memory location of the storage device 230. The TLB 220 includes a fixed number of entries for mapping virtual addresses to physical addresses.

The storage device 230 may comprise a storage controller 232 and a memory 238 (which may be or may include DRAM and/or SRAM). The storage controller 232 may comprise a command scheduler 234 that manages execution of commands received from the host device 210. The command scheduler 234 ensures that the commands are executed efficiently and in a sequential manner.

A memory request for performing a memory operation may be received from one or more applications running on the host device 210. The memory request may be in form of an application programming interface (API) call. Memset( ) is one such API call that is invoked by the one or more applications for initialization of a memory location within the DRAM 238. Similar API calls such as memcpy( ) or memmove( ) may be used for copying or moving data from one location to another location within the DRAM 238. It may be noted that the memory request may comprise a source address, a destination address, and other related information associated with the data utilized in the memory operations. A data bus 224 is used for transferring data from the source address to the destination address, while the address bus 226 is used for transferring address related information to the storage device 230. An example memory copy operation of the host device 210 is described in the forthcoming paragraphs.

The DRAM 238 comprises various memory location addresses, which may be accessed based on the memory operation being performed. For instance, a memory initialization operation accesses a memory location for initialization. Address of such memory location is known as meminit address 240. Similarly, during a memory copy and move operations, a source address 242 and a destination address 244 are accessed to perform read/write operations.

In a conventional memory copy operation, once a memcpy( ) API call is invoked, data is first copied or read from a source address 242 of the DRAM 238 and written into a destination address 244. The API call that triggers the particular memory operation specifies information such as the source address 242 indicating the location from where the data needs to be read or copied and the destination address 244 indicating the location where the data needs to be written. Initially, the data copied from the source address 242 is first temporarily stored into a temporary location which may be the cache memory residing in the host device 210. The data is then written from the temporary location into the destination address 244. The copy operation may be performed block by block using one or more caches such as data cache 214 or instruction cache 212 of the host device 210. However, copying the data first to a temporary location consumes additional CPU cycles, which may otherwise be utilized for other CPU intensive operations.

Such memory copy operations (where a cache memory is used for temporarily storing the data before it is copied to the destination address 244) are usually referred as non-direct memory access (DMA) operations. In a non-DMA operation, the CPU 222 is typically occupied for the entire duration of the memory operation and is therefore unavailable for other complex tasks also requiring CPU resources.

However, systems with DMA capabilities usually allow data to be moved or copied without intervention from the CPU 222. In such systems, a DMA engine is introduced which controls the transfer of data between the storage device 230 and a system memory (e.g., a system RAM). Thus, CPU 222 may although initiate the data transfer, however, may proceed to perform other operations, while the data transfer is managed by the DMA engine. But, even in a DMA data transfer operation, the processing load of the CPU 222 is not taken into consideration, thereby preventing effective utilization of CPU resources. If the processing load of the CPU is determined to be high, it may be advantageous to improve optimize the memory operations scheduled for execution. Likewise, if the processing load of the CPU is determined to be low, the CPU may be utilized for performing the memory operations.

To solve or improve upon the above-mentioned and other related problems, the techniques of example embodiments propose using a spare engine (that may be a part of a storage controller 232) for improving or optimizing the memory operations.

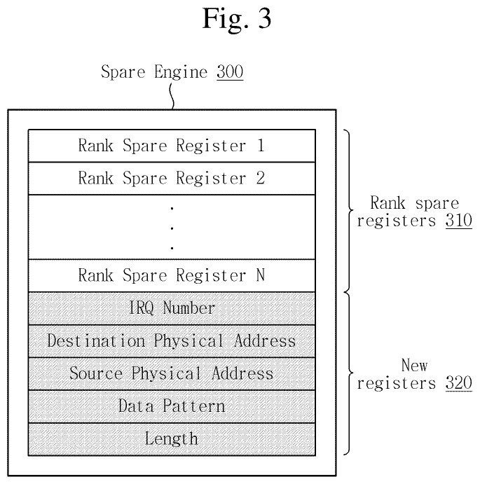

FIG. 3 illustrates a block diagram of a spare engine 300 of a storage device, in accordance with various example embodiments. As shown in FIG. 3, the spare engine 300 may comprise a plurality of registers. The plurality of registers is used in rank-level and bank-level operations performed by a storage controller of the storage device. These registers are also known as rank spare registers 310. Apart from the rank spare registers, there may be some additional or spare space which may be vacant and has not been allocated by the storage controller for any specific purpose. In various example embodiments, this spare space is utilized for improving or optimizing the memory operations. Specifically, one or more new registers are assigned/added into the spare space. The new registers 320 are registers which are allocated/added to store various data/instructions for improving or optimizing the memory operations in the present disclosure. In some example embodiments, instead of or in addition to allocating/adding new registers, the existing rank spare registers may be utilized for storing the various data/instructions for improving or optimizing the memory operations.

For instance, the new registers may comprise an interrupt request (IRQ) number register, a destination physical address register, a source physical address register, a data pattern register, and a length register. The IRQ number register may be configured to store a reference number related to an IRQ signal. In general, the interrupt request (IRQ) signal is a signal sent to the CPU to momentarily stop or interrupt CPU's operations. The signal can be sent by any device to interrupt the CPU so that the device gets some time to run its own operations. The device may include disk drive controllers, sound cards, printers, keyboards and mouses. For example, when a printer (not shown) finishes printing, the printer sends an IRQ signal to the CPU. All or most devices connected to the host device may communicate their IRQs using their IRQ number. The IRQ number facilitates appropriate CPU response by assigning priorities to the various devices. In various example embodiments, the IRQ signal may be utilized to inform the CPU regarding status of a memory operation (e.g., whether the memory operation is completed successfully or not).

The destination physical address register may store destination physical address(es) corresponding to the memory location(s) within the DRAM where data associated with a memory move or memory copy operation is to be written.

The source physical address register may store source physical address(es) corresponding to the memory location(s) within the DRAM where the data in a memory move or memory copy operation is to be read from.

The data pattern register may store value relating to a data pattern, which is a predefined data pattern provided by the DRAM manufacturer. The data pattern (also known as “memory pattern”) may refer to a specific arrangement of data stored within the DRAM 238.

The length register may be configured to store a total length of data to be read or written associated with a memory operation. The length may be represented in form of bits or bytes depending on the hardware configuration of the storage device.

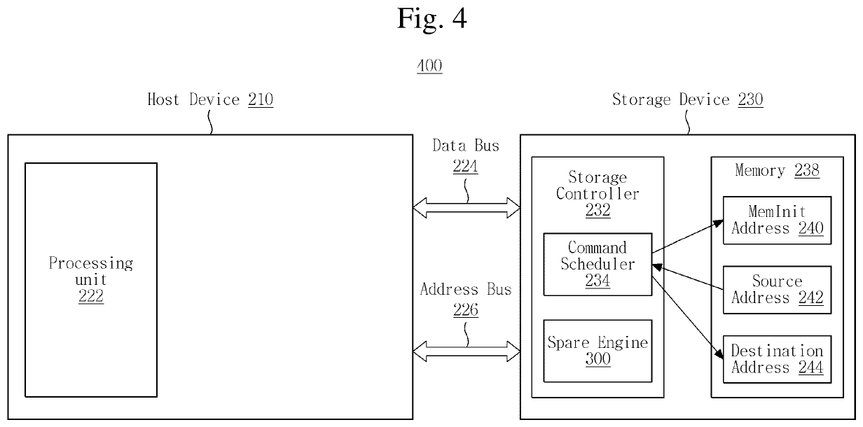

The techniques of example embodiments utilize the new registers 320 for improving or optimizing the memory operations, as discussed in connection with FIG. 4.

FIG. 4 illustrates a detailed block diagram of an example storage system 400 comprising a host device 210 and a storage device 230, in accordance with various example embodiments. The host device 210 as mentioned above may comprise a CPU or a processing unit 222. The storage device 230 may comprise the storage controller 232 and the DRAM 238. The storage controller 232 may comprise a command scheduler 234 and the spare engine 300 of FIG. 3.

The storage system 400 utilizes the spare engine 300 within the storage controller 232 of the storage device 230 for improving or optimizing the memory operations. In various example embodiments, the spare engine 300 within the storage controller 232 is utilized for storing information associated with the memory operation (e.g., address related information), which conventionally was stored within the cache or buffer memory of the CPU 222 of the host device 210. Thus, in performing the memory operation is the intervention of the CPU is reduced or minimized and CPU cycles used in performing such memory operations are significantly reduced.

When the operating system (for example, the kernel module) of the host device 210 receives a memory request from an application running on the host device 210, the kernel module transmits a request to processing unit 222 based on the memory request. The request may comprise information related to a type of at least one memory operation associated with the memory request. The type of the memory operation may comprise at least one of: a memory initialization operation, a data copy operation, and a data move operation. The processing unit 222 of FIG. 4 is configured to receive this request for performing the at least one memory operation on a storage device 230. Unlike the conventional operation, various example embodiments may first determines whether the CPU is capable of handling the memory request and performing the requested memory operation. Specifically, the processing unit or the CPU 222 of FIG. 4 is configured to determine a current processing load of the processing unit 222 upon receiving the request. The current processing load of the CPU 222 may indicate a number of processes which are currently being executed by the CPU 222 and/or a number of processes which are scheduled for execution by the CPU 222. Such processes may be stored in a CPU run queue maintained by the CPU scheduler. The CPU 222 determines the processing load by analysing the length of the CPU run queue.

If the length of the CPU run queue exceeds a threshold value such as a predetermined threshold value, the processing load on the CPU is considered to be high. Further, the processing unit 222 is configured to make this determination of whether the current processing load is high, by comparing the current processing load with a predetermined load threshold value. If the current processing load is determined to be high, the current processing unit 222 is configured to transmit a configuration request to the storage device 230. The configuration request comprises information related to an interrupt request (IRQ) number associated with the memory operation; a destination physical address associated with the memory operation; a source physical address associated with the memory operation; a data pattern associated with data utilized in the memory operation; and a length corresponding to the data utilized in the at least one memory operation.

Upon receiving the configuration request from the host device 210, the storage controller 232 configures a spare space within the storage controller 232. The configuring the spare space comprises allocating a plurality of registers 320 within the spare space for performing the at least one memory operation on the storage device. For example, configuring the spare space comprises allocating the plurality of registers 320 for storing data corresponding to the interrupt request (IRQ) number, the destination physical address, the source physical address, the data pattern, and the length.

After configuration of the spare space, the new registers 320 of the spare engine 300 are allocated and the registers are initialized with configuration details pertaining to the configuration request such as source address, destination address, IRQ number, data pattern, and length. While performing any memory operation, the storage system 400 utilizes the plurality of registers or the new registers 320 and there is no involvement of the TLB or the cache memory of the CPU 222. Hence, the CPU cycles are not wasted or are less likely to be wasted in storing or fetching data/addresses into/from the cache memories or the TLB, rather the address information is fetched directly from the new registers 320.

According to various example embodiments, when a memcpy( ) API call is invoked, CPU 222 configures the spare engine 300 of the storage controller 232 to store the source and destination address values of the block of memory to be copied, in the new registers 320. The storage controller accesses the source address 242 (that is stored in the source address register of the spare engine 300) to initiate a read operation. The data stored in the source physical address 242 is then read and written. to the destination address 244 (that is stored in the destination physical address register of the spare engine 300). Thus, the copy operation according to various example embodiments is optimized or improved upon as there is minimum or reduced CPU intervention during the copying process. Similarly, memory initialization and memory move operations also use minimum or reduced CPU cycles while performing the respective operations by accessing the data/information stored in new registers 320 directly.

In some non-limiting example embodiments, the spare space within the spare engine additionally may also comprise a buffer memory for temporarily storing the data associated with the at least one memory operation that is to be either written into the storage device or to be read from the storage device.

In some non-limiting example embodiments, the IRQ number stored in the spare register of the storage controller 232 may be utilized in sending an interrupt notification to the CPU 222 of the host device 210. The interrupt notification provides an indication regarding completion of said memory operation.

In some non-limiting example embodiments, apart from the current processing load of the CPU 222, a data size associated with the said memory operation may alternatively or additionally be considered before configuring the spare space. In some non-limiting example embodiments, the data size may be the size of a block of memory to be moved or copied. In such example embodiments, the processing unit 222 is configured to determine a size associated with said memory operation. Further the processing unit 222 is configured to transmit the configuration request to the storage device 230 to configure the spare space within the storage controller 232 of the storage device 230 in response to determining that the current processing load exceeds the load threshold value and the size associated with the memory operation exceeds a predefined size threshold value. In some non-limiting example embodiments, the size associated with the memory operation may be the amount of data to be moved or copied to the DRAM 238.

In some non-limiting example embodiments, the present application discloses a storage device 230 for improving or optimizing memory operations. The storage device 230 comprises a memory 238 and a storage controller 232 comprising a spare space and communicatively coupled with the memory 238. The storage controller 232 is configured to receive the configuration request from the host device for performing said memory operation; and in response to receiving the configuration request, configure the spare space within the storage controller 232 of the storage device 230. Here, the configuring the spare space comprises allocating a plurality of registers within the spare space for performing the said memory operation on the storage device 230.

It may be noted that the storage controller 232 of the storage device 230 configures the new registers 320 within the spare engine 300 for improving or optimizing the memory operations. In some non-limiting example embodiments, once a memory operation has been completed, the storage controller is configured to send an interrupt to the CPU 222 to notify regarding the completion of said memory request.

In some non-limiting example embodiments, techniques can be utilized for improving or optimizing memory operations where data needs to be copied or moved from one process to another process. For instance, during a fork( ) system call, new child processes are created, and data is copied from a parent process to the newly created child processes. Thus, the techniques of the present disclosure can be utilized in memory operations invoked in response to fork( ) system call, i.e., for transfer of inter-process data in a host computer. In this manner, the present disclosure utilizes a spare engine to conserve essential CPU resources and optimize the memory operations such that CPU resources are effective utilized.

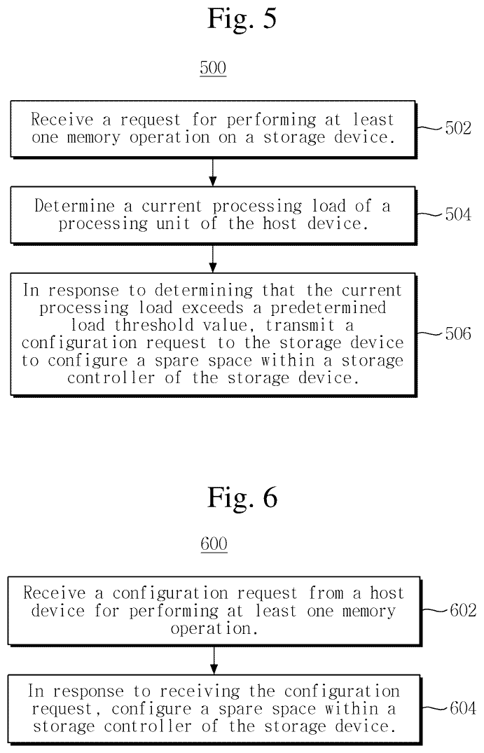

Referring now to FIG. 5 which illustrates a flow chart of a method 500 performed by a host device for improving or optimizing memory operations in accordance with various example embodiments. The various operations of method 500 may be performed by the host device 210 (particularly, using the processing unit 222 of the host device 210).

The method at block 502 comprises receiving a request for performing at least one memory operation on a storage device 230. In one of the non-limiting embodiments of the present disclosure, the request comprises information related to a type of the at least one memory operation. Further the type of the memory operation comprises at least one of: a memory initialization operation, a data copy operation, and a data move operation.

Further the method 500 at block 504 comprises determining a current processing load of a processing unit 222 of the host device 210, upon receiving the request for performing the at least one memory operation. In some non-limiting example embodiments, the method 500 further comprises determining a size associated with the at least one memory operation. Further, transmitting the configuration request to the storage device 230 comprises transmitting the configuration request to the storage device 230 to configure the spare space within the storage controller 232 of the storage device 230, in response to determining that the current processing load exceeds the load threshold value and the size associated with the at least one memory operation exceeds a predefined size threshold value.

Furthermore, the method at block 506 comprises transmitting a configuration request to the storage device 230 to configure a spare space within a storage controller 232 of the storage device 230 in response to determining that the current processing load exceeds a predetermined load threshold value. Herein the configuring the spare space comprises allocating a plurality of registers within the spare space for performing the at least one memory operation on the storage device 230. In some non-limiting example embodiments, the configuration request comprises information related to one or more of an interrupt request (IRQ) number associated with the at least one memory operation; a destination physical address associated with the at least one memory operation; a source physical address associated with the at least one memory operation; a data pattern associated with data utilized in the at least one memory operation; and a length corresponding to the data utilized in the at least one memory operation.

In some non-limiting example embodiments, the method 500 further comprises receiving an interrupt notification from the storage device 230, wherein the interrupt notification provides an indication regarding completion of the at least one memory operation.

FIG. 6 illustrates a flow chart of another method 600 method performed by a storage device 230 for improving or optimizing memory operations in accordance with various example embodiments. The various operations of the method 600 may be performed by the storage device 230 (particularly, using the storage controller 232 of the storage device 230).

The method 600 comprises at block 602 receiving a configuration request from a host device for performing at least one memory operation. In one of the non-limiting embodiments of the present disclosure, the at least memory operation comprises at least one of: a memory initialization operation, a data copy operation, and a data move operation.

The method 600 comprises block 604 configuring a spare space within a storage controller 232 of the storage device 230 in response to receiving the configuration request. Further configuring the spare space comprises allocating a plurality of registers within the spare space for performing the at least one memory operation on the storage device 230. In some non-limiting example embodiments, the configuration request comprises information related to one or more of: an interrupt request (IRQ) number associated with the at least one memory operation; a destination physical address associated with the at least one memory operation; a source physical address associated with the at least one memory operation; a data pattern associated with data utilized in the at least one memory operation; and a length corresponding to the data utilized in the at least one memory operation.

In some non-limiting example embodiments, allocating the plurality of registers comprises allocating at least one register from the plurality of registers for each of the IRQ number, the destination physical address, the source physical address associated the data pattern, and the length. The allocation of the plurality of registers further comprises utilizing the plurality of registers for performing the at least one memory operation on the storage device.

In some non-limiting example embodiments, the method 600 performed by a storage device 230 further comprises transmitting an interrupt notification to the host device 210, wherein the interrupt notification provides an indication regarding completion of the at least one memory operation.

In light of the technical advancements provided by the proposed method and the system the claimed steps, as discussed above, are not routine, conventional, or well-known aspects in the art, as the claimed steps provide the aforesaid solutions to the technical problems existing in the conventional technologies. Further, the claimed steps clearly bring an improvement in the functioning of the system itself, as the claimed steps provide a technical solution to a technical problem.

The above methods 500 and 600 may be described in the general context of computer executable instructions. Generally, computer executable instructions can include routines, programs, objects, components, data structures, procedures, modules, and functions, which perform specific functions or implement specific abstract data types.

The order in which the various operations of the methods are described is not intended to be construed as a limitation, and any number of the described method blocks can be combined in any order to implement the method. Additionally, individual blocks may be deleted from the methods without departing from the spirit and scope of the subject matter described herein. Furthermore, the methods can be implemented in any suitable hardware, software, firmware, or combination thereof.

The various operations of methods described above may be performed by any suitable means or approaches capable of performing the corresponding functions. The approaches may include various hardware and/or software component(s) and/or module(s) shown in FIGS. 1-6. Generally, where there are operations illustrated in Figures, those operations may have corresponding counterpart means-plus-function components.

It may be noted here that the subject matter of some or all example embodiments described with reference to FIGS. 1-6 may be relevant for the methods and the same is not repeated for the sake of brevity.

In a non-limiting embodiment of the present disclosure, one or more non-transitory computer-readable media may be utilized for implementing the embodiments consistent with the present disclosure. Certain aspects may comprise a computer program product to perform the operations presented herein. For example, such a computer program product may comprise a computer readable media having instructions stored (and/or encoded) thereon, the instructions being executable by one or more processors to perform the operations described herein. For certain aspects, the computer program product may include packaging material.

Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware. Additionally example embodiments are not necessarily mutually exclusive with one another. For example, some example embodiments may include one or more features described with reference to one or more figures, and may also include one or more other features described with reference to one or more other figures.

1. A method performed by a host device, comprising:
receiving a request to perform at least one memory operation on a storage device;
upon receiving the request to perform the at least one memory operation, determining a current processing load of a processing unit of the host device; and
in response to determining that the current processing load exceeds a load threshold value, transmitting a configuration request to the storage device to configure a spare space within a storage controller of the storage device, wherein
the configuring the spare space comprises allocating a plurality of registers within the spare space to perform the at least one memory operation on the storage device.

2. The method as claimed in claim 1, wherein
the request comprises information related to a type of the at least one memory operation, and
the type of the at least memory operation comprises at least one of a memory initialization operation, a data copy operation, and a data move operation.

3. The method as claimed in claim 1, further comprising:
receiving an interrupt notification from the storage device, wherein the interrupt notification provides an indication regarding completion of the at least one memory operation.

4. The method as claimed in claim 1, further comprising:
determining a size associated with the at least one memory operation, and
wherein the transmitting the configuration request to the storage device comprises transmitting the configuration request to the storage device to configure the spare space within the storage controller of the storage device, in response to determining that the current processing load exceeds the load threshold value and the size associated with the at least one memory operation exceeds a size threshold value.

5. The method as claimed in claim 1, wherein the configuration request comprises information related to one or more of:
an interrupt request (IRQ) number associated with the at least one memory operation,
a destination physical address associated with the at least one memory operation,
a source physical address associated with the at least one memory operation,
a data pattern associated with data utilized in the at least one memory operation, and
a length corresponding to the data utilized in the at least one memory operation.

6. A method performed by a storage device to improve memory operations, comprising:
receiving a configuration request from a host device to perform at least one memory operation; and
in response to receiving the configuration request, configuring a spare space within a storage controller of the storage device, wherein the configuring the spare space comprises allocating a plurality of registers within the spare space to perform the at least one memory operation on the storage device.

7. The method as claimed in claim 6, wherein the at least memory operation comprises at least one of a memory initialization operation, a data copy operation, and a data move operation.

8. The method as claimed in claim 6, further comprising:
transmitting an interrupt notification to the host device, wherein the interrupt notification provides an indication regarding completion of the at least one memory operation.

9. The method as claimed in claim 6, wherein the configuration request comprises information related to one or more of:
an interrupt request (IRQ) number associated with the at least one memory operation;
a destination physical address associated with the at least one memory operation;
a source physical address associated with the at least one memory operation;
a data pattern associated with data utilized in the at least one memory operation; and
a length corresponding to the data utilized in the at least one memory operation.

10. The method as claimed in claim 9, wherein allocating the plurality of registers comprises:
allocating at least one register from the plurality of registers for each of the IRQ number, the destination physical address, the source physical address associated the data pattern, and the length; and
utilizing the plurality of registers to perform the at least one memory operation on the storage device.

11. The method as claimed in claim 6, wherein the spare space further comprises a buffer memory for temporarily storing at least one of:
data associated with the at least one memory operation to be written into the storage device; and
data associated with the at least one memory operation to be read from the storage device.

12. A host device, comprising:
a host memory; and
a processing unit communicatively coupled with the host memory, wherein the processing unit is configured to,
receive a request to perform at least one memory operation on a storage device;
upon receiving the request to perform the at least one memory operation, determine a current processing load of the processing unit of the host device; and
in response to determining that the current processing load exceeds a load threshold value, transmit a configuration request to the storage device to configure a spare space within a storage controller of the storage device, wherein configuring the spare space comprises allocating a plurality of registers within the spare space to perform the at least one memory operation on the storage device.

13. The host device as claimed in claim 12, wherein the request comprises information related to a type of the at least one memory operation, and wherein the type of the at least memory operation comprises at least one of: a memory initialization operation, a data copy operation, and a data move operation.

14. The host device as claimed in claim 12, wherein the processing unit is further configured to:
receive an interrupt notification from the storage device, wherein the interrupt notification provides an indication regarding completion of the at least one memory operation.

15. The host device as claimed in claim 12, wherein
the processing unit is further configured to determine a size associated with the at least one memory operation, and
to transmit the configuration request to the storage device, the processing unit is configured to transmit the configuration request to the storage device to configure the spare space within the storage controller of the storage device, in response to determining that the current processing load exceeds the load threshold value and the size associated with the at least one memory operation exceeds a size threshold value.

16. The host device as claimed in claim 12, wherein the configuration request comprises information related to one or more of:
an interrupt request (IRQ) number associated with the at least one memory operation;
a destination physical address associated with the at least one memory operation;
a source physical address associated with the at least one memory operation;
a data pattern associated with data utilized in the at least one memory operation; and
a length corresponding to the data utilized in the at least one memory operation.

17-24. (canceled)
